(19) United States
(12) Patent Application Publication
(10) Pub. No.: US 2021/0097162 A1
(43) Pub. Date: Apr. 1, 2021

(54) METHOD AND APPARATUS FOR UNLOCKING A SCREEN AND MOBILE ELECTRONIC DEVICE

(71) Applicant: SONY CORPORATION, Tokyo (JP)

(72) Inventor: Jie HOU, Beijing (CN)

(21) Appl. No.: 16/756,801

(22) PCT Filed: Jan. 23, 2018
(86) PCT No.: PCT/CN2018/073757

§ 371 Date: Apr. 16, 2020

(51) Int. Cl. G06F 21/32; G06F 21/35

(52) U.S. Cl. CPC G06F 21/32; G06F 2221/2115; G06F 21/35

(57) ABSTRACT

A method and apparatus for unlocking a screen and a mobile electronic device. The method includes: triggering an unlocking program based on biometric feature identification in the mobile electronic device by approaching or contacting a near field communication tag by the mobile electronic device; and unlocking a screen of the mobile electronic device by using a biometric feature of a user. Hence, not only can security be ensured by the NFC tag, but also the screen can be unlocked via the biometric feature, which may improve convenience by not requiring a user to memorize a password (improving user experience).

### TECHNICAL FIELD

This disclosure relates to the field of mobile device technologies, and in particular to a method and apparatus for unlocking a screen and a mobile electronic device.

### BACKGROUND

Mobile electronic devices (such as smart mobile phones, tablet PCs, etc.) are widely used. Currently, mobile electronic devices use various mobile operating systems, such as IOS and Android. Various application programs (or referred to as applications or apps) may operate in these mobile operating systems, thereby achieving various functions.

For the sake of security, a screen of a mobile electronic device may be locked when user input is not received within a certain period of time (such as 10 seconds) and a password or a biometric feature (such as a fingerprint) may be required to unlock the mobile electronic device. Furthermore, when the mobile electronic device is rooted or switched on, the screen of the mobile electronic device may be locked and a user password may be required to unlock the device.

It should be noted that the above description of the background is merely provided for clear and complete explanation of this disclosure and for easy understanding by those skilled in the art. It should not be assumed that the above description is known to those skilled in the art, just because the above description is found in the background section of this disclosure.

### SUMMARY

In some scenarios (such as booting or switching on of a mobile electronic device), a screen must be unlocked by inputting a password or a pattern. If the user forgets the password or the pattern, the user may need to contact client service support and the mobile electronic device may need to be reflashed or reformated, thereby inconveniencing the user.

Embodiments of this disclosure provide a method and apparatus for unlocking a screen and a mobile electronic device, which are expected to improve user convenience without decreasing security.

According to a first aspect of the embodiments of this disclosure, there is provided a method for unlocking a screen of a mobile electronic device, the method including:

sensing with the mobile electronic device and a near field communication tag;

determining with the mobile electronic device whether the near field communication tag is an approved near field communication tag;

when the sensed near field communication tag is the approved near field communication tag:
receiving a biometric feature of the user; and
determining whether the received biometric feature matches an authorized biometric feature;
when the received biometric feature matches the authorized biometric feature, unlocking a screen of the mobile electronic device.

In an embodiment, when the mobile electronic device is rooted or switched on and the approved near field communication tag is not sensed by the mobile device, requiring a passcode to unlock the screen of the mobile electronic device.

In an embodiment, the biometric feature of the user includes at least one of the following of the user: a fingerprint, a face, an iris, a palm print, or a voice.

In an embodiment, the method further includes:

when the authorized near field communication tag is sensed, an unlocking program is executed and the unlocked program receives the biometric feature from the user.

In an embodiment, the near field communication tag includes a universal tag, and a configuration program is used in the mobile electronic device to identify the near field communication tag as the authorized near field communication tag.

In an embodiment, the configuration program is a universal third-party program.

In an embodiment, the near field communication tag includes a specific tag of the mobile electronic device, and the near field communication tag and the mobile electronic device are bound in advance.

In an embodiment, the near field communication tag contains identification information of the mobile electronic device.

According to a second aspect of the embodiments of this disclosure, there is provided a mobile electronic device, including:

a screen;

a near field communication sensor configured to sense a near field communication tag;

a biometric sensor configured to generate biometric feature data from a biometric feature of a user of the mobile electronic device;

a processor configured to:
lock the screen to prevent operation of the mobile electronic device by an unauthorized user;
receive data from the sensor regarding the near field communication tag;
determining whether the near field communication tag is an approved near field communication tag;
when the sensed near field communication tag is the approved near field communication tag:
   receiving the biometric feature data from the biometric sensor;
   determining whether the received biometric feature matches an authorized biometric feature;
   when the received biometric feature matches the authorized biometric feature, unlocking a screen of the mobile electronic device.

In an embodiment, when the mobile electronic device is rooted or switched on and the approved near field communication tag is not sensed by the mobile device, requiring a passcode to unlock the screen of the mobile electronic device.

In an embodiment, the biometric feature of the user includes at least one of the following of the user: a fingerprint, a face, an iris, a palm print, or a voice identification.

In an embodiment, the processor is further configured to:

when the authorized near field communication tag is sensed, execute an unlocking program, such that the unlocked program receives the biometric feature data

In an embodiment, the near field communication tag includes a universal tag, and the processor executes a configuration program to identify the near field communication tag as the authorized near field communication tag.

In an embodiment, the near field communication tag includes a specific tag of the mobile electronic device, and the near field communication tag and the mobile electronic device are bound in advance.

In an embodiment, the near field communication tag contains identification information of the mobile electronic device.

Advantages of the embodiments of this disclosure exist in that by approaching or contacting the near field communication (NFC) tag by the mobile electronic device, the unlocking program based on biometric feature identification in the mobile electronic device is triggered or enabled, and the screen of the mobile electronic device is unlocked by using a biometric feature of a user. Hence, not only can security be ensured by the NFC tag, but also the screen can be unlocked via the biometric feature, which may improve convenience by not requiring a user to keep track of a password.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components, but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a flowchart of the method for unlocking a screen of an embodiment of this disclosure;

FIG. 2 is a schematic diagram of an example of unlocking a screen of the embodiment of this disclosure;

FIG. 3 is another flowchart of the method for unlocking a screen of the embodiment of this disclosure;

FIG. 4 is a schematic diagram of the apparatus for unlocking a screen of an embodiment of this disclosure; and

FIG. 5 is a schematic diagram of a systematic structure of the mobile electronic device of an embodiment of this disclosure.

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

The interchangeable terms “electronic equipment” and “electronic device” may include portable radio communication equipment. The term “portable radio communication equipment”, which hereinafter is referred to as a “mobile radio terminal”, “portable electronic device”, or “portable communication device”, comprises all apparatuses such as mobile telephones, pagers, communicators, electronic organizers, personal digital assistants (PDAs), smart phones, media players, tablet PCs, portable communication devices, portable game devices, or the like.

The term “unit” may have a conventional meaning in the field of electronics, and an electronic device and/or an electric device may include, for example, an electronic and/or electric circuit(s), device(s), module(s), processor(s), memory(ies), logic solid and/or discrete device(s), a computer program or instruction(s) executing a corresponding task, procedure, computation, output and/or display functions, or the like; however, this disclosure is not limited thereto.

In the present application, embodiments of the disclosure are described primarily in the context of a portable electronic device in the form of a mobile telephone (also referred to as “mobile phone”). However, it shall be appreciated that the disclosure is not limited to the context of a mobile telephone and may relate to any type of appropriate electronic apparatus, examples of such type of electronic apparatus including a digital single lens reflex camera, a digital mirrorless camera, a smart mobile phone, a tablet PC, a portable digital camera, a media player, a portable game device, a PDA, a computer, or the like.

### Embodiment of the First Aspect

The embodiment of this disclosure provides a method for unlocking a screen of a mobile electronic device.

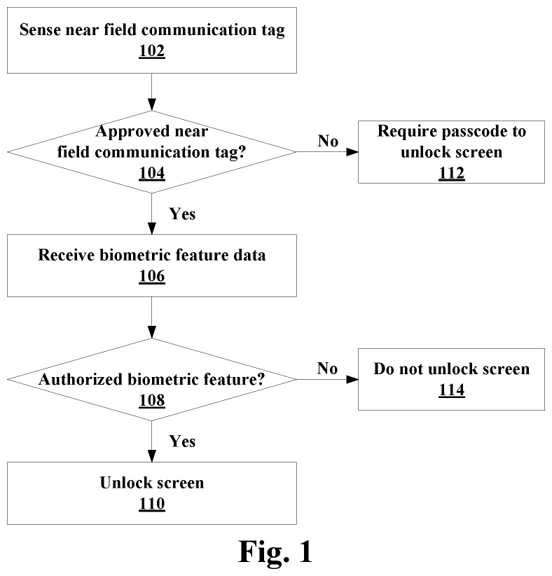

FIG. 1 is a flowchart of the method 100 for unlocking a screen of an embodiment of this disclosure. In process block 102, a near field communication (NFC) tag is sensed by the mobile electronic device. For example, the NFC tag may be moved towards the mobile electronic device or the mobile electronic device may be moved toward the NFC tag.

In determining block 104, the mobile electronic device determines whether the near field communication tag is an approved near field communication tag. If the near field communication tag is an approved near field communication tag, processing moves to process block 106.

In process block 106, a biometric feature of the user is received. If the near field communication tag is not an approved near field communication tag or if a near field communication tag is not sensed, then processing may move to optional process block 112.

In optional process block 112, a passcode is required to to unlock the screen. As will be understood by one of ordinary skill in the art, the passcode may refer to a password (e.g., a combination of keystrokes) or a pattern (e.g., drawn by a user on the screen of the mobile electronic device).

In determining block 108, a determinination is made regarding whether the received biometric feature matches an authorized biometric feature. When the received biometric feature matches the authorized biometric feature, processing moves to process block 110.

In process block 110, a screen of the mobile electronic device is unlocked. When the received biometric feature does not match the authorized biometric feature, processing may move to process block 114. In optional process block 114, the screen of the mobile electronic device remains locked.

In an embodiment, the mobile electronic device may operate a mobile operating system, such as IOS, or Android, etc., and the mobile operating system may operate one or more applications; however, this disclosure is not limited thereto, and all mobile electronic devices capable of operating multiple applications are applicable to this disclosure. Following description shall be given by taking a smart mobile phone operating an Android system as an example; however, this disclosure is not limited thereto.

In an embodiment, when the mobile electronic device is rooted or switched on, the mobile device sensing the NFC tag may trigger an unlocking program configured to perform biometric feature identification.

In an embodiment, the biometric feature identification includes at least one of the following: fingerprint identification, face identification, iris identification, palm print identification, and voice identification; however, this disclosure is not limited thereto. Following description shall be given by taking fingerprint identification as an example.

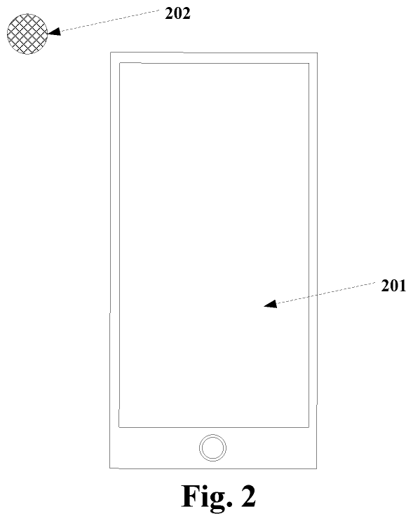

FIG. 2 is a schematic diagram of an example of unlocking a screen of the embodiment of this disclosure. As shown in FIG. 2, a mobile electronic device 201, for example, is bound to a NFC tag 202 in advance. The NFC tag 202 may be adhered to a wall in a house, or may be adhered to a computer desk in an office, or may be placed in a wallet. However, this disclosure is not limited thereto; for example, the NFC tag 202 may be placed at any location where the mobile electronic device 201 is often rooted or switched on.

For example, the NFC tag 202 may be configured in advance, so that the NFC tag 202 is associated with the unlocking program based on fingerprint identification in the mobile electronic device 201. That is, an unlocking program of the fingerprint identification is capable of being triggered by the NFC tag 202. And the relevant art may be referred to for how to configure the NFC tag and how to associate.

In a case, for example, where the mobile electronic device 201 is rooted or switched on, as shown in FIG. 2, the mobile electronic device 201 may be made to approach or contact the NFC tag 202, thus, the unlocking program based on the fingerprint identification in the mobile electronic device 201 is triggered or activated, and the screen of the mobile electronic device 201 can be unlocked by using the fingerprint of a user.

Hence, on the one hand, the NFC tag is needed to trigger (or enable or activate) the unlocking program based on the biometric feature identification, and as the NFC tag is a component different from the mobile electronic device, security can be ensured by the NFC tag. And on the other hand, the screen can be unlocked via the biometric feature, which may improve convenience without memorizing a password, and improve users' experiences.

As will be understood by one of ordinary skill in the art, the unlocking program may be a third party application or a feature of the operating system (OS) running on the mobile electronic device.

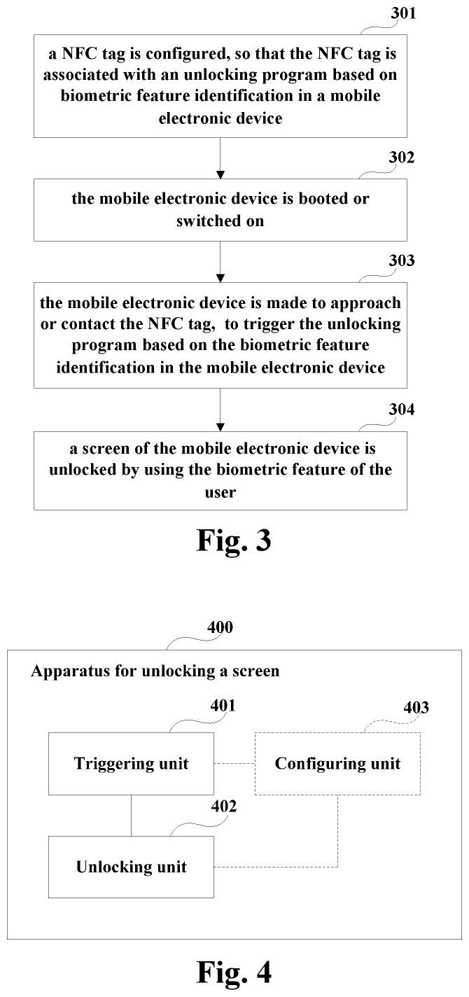

FIG. 3 is another flowchart of the method for unlocking a screen of the embodiment of this disclosure. As shown in FIG. 3, the method includes:

Block 301: a NFC tag is configured so that the NFC tag is associated with the unlocking program based on biometric feature identification in a mobile electronic device.

In an embodiment, the NFC tag may be a universal tag, which may be purchased from an online store (such as Amazon, and Tmall, etc.), and a configuration program is used in the mobile electronic device to configure the NFC tag.

For example, the configuration program is a universal third-party program. The third-party program may be downloaded in the mobile electronic device, and then the NFC tag is configured (i.e., authorized) by the third-party program as being used for a specific purpose.

For example, the NFC tag is set to be triggering (or enabling, or activating) the screen unlocking program based on the fingerprint identification only when the mobile electronic device is booted or started up. That is, the mobile electronic device may be set to require that a user enter a passcode to unlock the screen when the mobile electronic device is turned on. But, when an authorized NFC tag is sensed by the mobile device, a user may unlock the screen by using a biometric feature.

In another embodiment, the NFC tag may also be a specific tag of the mobile electronic device, and the NFC tag and the mobile electronic device are bound in advance.

For example, in ex-works of the mobile electronic device, the NFC tag may be included by the manufacturer with the mobile electronic device, and the NFC tag may contain identification information of the mobile electronic device, such as an international mobile equipment identity (IMEI).

It should be noted that the NFC tag is only illustrated above. However, this disclosure is not limited thereto, and the relevant art may be referred to details of the NFC tag.

Block 302: the mobile electronic device is booted or switched on;

Block 303: the mobile electronic device is made to approach or contact the NFC tag, and to trigger (or enable or activate) the unlocking program based on the biometric feature identification in the mobile electronic device.

As the mobile electronic device approaches the NFC tag, the NFC tag is sensed by an NFC sensor. Upon sensing the NFC tag, the mobile electronic device may determine that the NFC tag is an authorized NFC tag (e.g., an identifier of the NFC tag has been stored by the mobile electronic device as an authorized or approved NFC tag). Upon determining that the NFC tag is authorized, the mobile electronic device triggers the unlocking program. Upon receiving biometric feature information from the user (e.g., from a biometric sensor), the mobile electronic device (e.g., via the unlocking program) determines whether the biometric feature information matches authorized biometric information stored in the mobile electronic.

Block 304: the screen of the mobile electronic device is unlocked by using the biometric feature of the user. That is, if the biometric feature information matches authorized biometric information, then the mobile electronic device is unlocked.

It should be noted that the embodiment of this disclosure is only illustrated above; however, this disclosure is not limited thereto. For example, an order execution of the blocks or steps may be adjusted, and furthermore, some blocks or steps may be added or some blocks or steps thereof may be omitted. And appropriate modification may be made by those skilled in the art according to the above contents, without being limited to what is contained in FIG. 3.

For example, in a case where unlocking is performed based on the fingerprint identification, in making the mobile electronic device to approach or contact the NFC tag in block 303, a finger may be placed on the home key (i.e., the location of the biometric sensor) at the same time. Hence, while the unlocking program based on the fingerprint identification is triggered (or enabled or activated) by the NFC tag, the screen of the mobile electronic device may be unlocked by the print of the finger. Thus, blocks 303 and 304 may be executed simultaneously or almost simultaneously.

For another example, in a case where unlocking is performed based on the face identification, in making the mobile electronic device to approach or contact the NFC tag in block 303, the face may be aligned with a camera of the mobile electronic device (i.e., the biometric sensor in this example). Hence, while the unlocking program based on the face identification is triggered (or enabled or activated) by the NFC tag, the screen of the mobile electronic device may be unlocked by the face. Thus, blocks 303 and 304 may be executed simultaneously or almost simultaneously.

It can be seen from the above embodiment that by approaching or contacting the NFC tag by the mobile electronic device, the unlocking program based on biometric feature identification in the mobile electronic device is triggered or enabled, and the screen of the mobile electronic device is unlocked by using a biometric feature of a user. Hence, not only security may be ensured by the NFC tag, but also the screen may be unlocked via the biometric feature, which may improve convenience without memorizing a password, and improve users' experiences.

As will be understood by one of ordinary skill in the art, while the mobile electronic device is described as approaching or contacting the NFC tag, it may be the mobile electronic device that is moved towards the NFC tag, the NFC tag that is moved towards the mobile electronic device, or a combination thereof.

### Embodiment of the Second Aspect

The embodiment of this disclosure provides an apparatus for unlocking a screen, which may be a mobile electronic device, or a or some component(s) or assembly/assemblies configured in the mobile electronic device, with contents identical to those in Embodiment of the first aspect being not going to be described herein any further.

FIG. 4 is a schematic diagram of the apparatus for unlocking a screen of an embodiment of this disclosure. As shown in FIG. 4, the apparatus 400 for unlocking a screen includes:

a triggering unit 401 configured to trigger an unlocking program based on biometric feature identification in the mobile electronic device by approaching or contacting a near field communication tag by the mobile electronic device; and

an unlocking unit 402 configured to unlock a screen of the mobile electronic device by using a biometric feature of a user.

As shown in FIG. 4, the apparatus 400 may further include:

a configuring unit 403 configured to configure the near field communication tag, so that the near field communication tag is associated with the unlocking program based on biometric feature identification.

In an embodiment, the triggering unit 401, the unlocking unit 402 and the configuring unit 403 may be, for example, carried out by software, that is, they may be software modules formed by software codes. These units may be stored in a non-transitory computer readable medium (memory) of the mobile electronic device, and their functions may be carried out by the memory and a processor. However, this disclosure is not limited thereto; for example, these units may also be chips into which codes are written. And these particular implementations are not limited in this disclosure.

It should be noted that the components or modules related to this disclosure are only described above; however, this disclosure is not limited thereto. And the apparatus 400 for unlocking a screen may further include other components or modules, and the relevant art may be referred to for details of these components or modules.

It can be seen from the above embodiment that by approaching or contacting the NFC tag by the mobile electronic device, the unlocking program based on biometric feature identification in the mobile electronic device is triggered or enabled, and the screen of the mobile electronic device is unlocked by using a biometric feature of a user. Hence, not only security may be ensured by the NFC tag, but also the screen may be unlocked via the biometric feature, which may improve convenience without memorizing a password, and improve users' experiences.

### Embodiment of the Third Aspect

The embodiment of this disclosure provides a mobile electronic device, which may be a mobile phone, a tablet PC, a portable digital camera, a media player, a portable game device, a PDA, a computer, or the like, and this embodiment is not limited thereto.

In this embodiment, the mobile electronic device may be a smart mobile phone; however, this disclosure is not limited thereto.

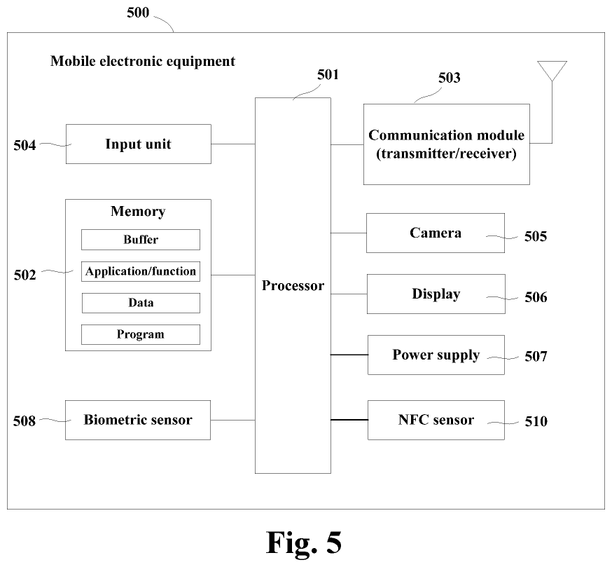

FIG. 5 is a block diagram of a systematic structure of the mobile electronic device of the embodiment of this disclosure. The mobile electronic device 500 may include a processor 501, a memory (non-transitory computer readable medium) 502, a biometric sensor 508, and an NFC sensor 510. The memory 502 may be coupled to the processor 501 and store instructions executed by the processor 501. It should be noted that this figure is illustrative only, and other types of structures may also be used, so as to supplement or replace this structure and achieve a telecommunications function or other functions.

As will be understood by one of ordinary skill in the art, the processor 501 (also referred to as circuitry) may have various implementations. For example, the processor 501 may include any suitable device, such as a CPU, programmable circuit, integrated circuit, memory and I/O circuits, an application specific integrated circuit, microcontroller, complex programmable logic device, other programmable circuits, or the like. The processor 501 may also include a non-transitory computer readable medium, such as random access memory (RAM), a read-only memory (ROM), an erasable programmable read-only memory (EPROM or Flash memory), or any other suitable medium. Instructions for performing the method described below may be stored in the non-transitory computer readable medium and executed by the processor 501. The processor 501 may be communicatively coupled to the computer readable medium 502, biometric sensor 508, and NFC sensor 510 through a system bus, mother board, or using any other suitable structure known in the art.

As will be understood by one of ordinary skill in the art, the biometric sensor 508 may comprise any hardware sensor configured to generate biometric feature data from a biometric feature of a user. The biometric feature may comprise a fingerprint, palm print, iris, face, or a voice of the user. The biometric sensor 508 measures a characteristic of the biometric feature to generate biometric feature data. For example, the biometric sensor 508 may comprise a finger print reader, a palm print reader, the camera 505, a light source and photodetector, a sound sensor (e.g., a microphone), an accelerometer, or any suitable sensor for generating biometric feature data from a biometric feature.

As will be understood by one of ordinary skill in the art, the NFC sensor 510 may comprise any suitable device for sensing an NFC tag. The NFC sensor 510 may comprise an antenna and/or transmitter for sending data via near field communication. For example, the NFC sensor 510 may be embodied as the communication module 503.

In an implementation, the functions of the apparatus 400 for unlocking a screen may be integrated into the processor 501. For example, the processor 501 may be configured to perform the following control by executing the instructions: triggering an unlocking program based on biometric feature identification in the mobile electronic device by approaching or contacting a near field communication tag by the mobile electronic device; and unlocking a screen of the mobile electronic device by using a biometric feature of a user.

In an embodiment, when the mobile electronic device is rooted or switched on, the unlocking program based on biometric feature identification in the mobile electronic device is triggered (or enabled or activated) by the NFC tag.

In an embodiment, the biometric feature identification includes at least one of the following: fingerprint identification, face identification, iris identification, palm print identification, and voice identification.

In an embodiment, the processor 501 may be configured to perform the following control by executing the instructions: configuring the near field communication tag, so that the near field communication tag is associated with the unlocking program based on biometric feature identification.

In an embodiment, the NFC tag is a universal tag, and a configuration program is used in the mobile electronic device to configure the NFC tag.

In an embodiment, the NFC tag is a specific tag of the mobile electronic device, and the NFC tag and the mobile electronic device are bound in advance.

In another implementation, the apparatus 400 for unlocking a screen and the processor 501 may be configured separately. For example, the apparatus 400 for unlocking a screen may be configured as a chip connected to the processor 501, with its functions being realized under control of the processor 501.

As shown in FIG. 5, the mobile electronic device 500 may further include a communication module 503, an input unit 504, a camera 505, a display 506 and a power supply 507.

The processor 501 (sometimes referred to as a controller or control, which may include a microprocessor or other processor devices and/or logic devices) receives input and controls operations of every components of the mobile electronic device 500. The input unit 504 provides input to the processor 501. The input unit 504 is, for example, a button or a touch input device. And the camera 505 is configured to capture image data, and provide the captured image data to the processor 501 for use in a conventional manner, such as storage, and transmission, etc.

The power supply 507 is configured to supply power to the mobile electronic device 500. And the display 506 is configured to display objects to be displayed, such as images, and words, etc. The display may be, for example, an LCD display or an LED display; however, this disclosure is not limited thereto.

The non-transitory computer readable medium (memory) 502 may be a solid memory, such as a read-only memory (ROM), a random access memory (RAM), and a SIM card, etc. It may also be such a memory that may store information when power is off, may be selectively erased, and may be provided with more data, and an example of such a memory is sometimes referred to as an EPROM, etc. The memory 502 may also be another type of device. The memory 502 may include a buffer memory (sometimes referred to as a buffer). And the memory 502 may include an application/function storage portion configured to store applications and function programs or procedures executing operations of the mobile electronic device 500 via the processor 501.

The memory 502 may further include a data storage portion configured to store data, such as a contact, digital data, a picture, a voice and/or any other data used by the mobile electronic device 500. A driver storage portion of the memory 502 includes various drivers of the mobile electronic device 500 for communication functions and/or for executing other functions (such as message transmission application, and directory application, etc.) of the mobile electronic device 500.

The communication module 503 is a transmitter/receiver transmitting and receiving signals via antennas. The communication module (transmitter/receiver) 503 is coupled to the processor 501 to provide input signals and receive output signals, which may be identical to a case in a conventional communication terminal. Based on different communication technologies, in the same mobile electronic device, multiple communication modules 503, such as a cellular network module, a Bluetooth module and/or a WLAN module, etc., may be provided, so as to achieve general telecommunications functions.

It should be noted that FIG. 5 only illustrates a part of the structure of the mobile electronic device 500. The mobile electronic device 500 does not necessarily include all the components shown in FIG. 5. And furthermore, the mobile electronic device 500 may include components not shown in FIG. 5, and the relevant art may be referred to.

An embodiment of the present disclosure provides a computer readable program code, which, when executed in a mobile electronic device, will cause the mobile electronic device to carry out the method for unlocking a screen as described in the embodiment of the first aspect.

An embodiment of the present disclosure provides a computer readable medium, including a computer readable program code, which will cause a mobile electronic device to carry out the method for unlocking a screen as described in the embodiment of the first aspect.

The preferred embodiments of the present disclosure are described above with reference to the drawings. The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

It should be understood that each of the parts of the present disclosure may be implemented by hardware, software, firmware, or a combination thereof In the above embodiments, multiple steps or methods may be realized by software or firmware that is stored in the memory and executed by an appropriate instruction executing system. For example, if it is realized by hardware, it may be realized by any one of the following technologies known in the art or a combination thereof as in another embodiment: a discrete logic circuit having a logic gate circuit for realizing logic functions of data signals, application-specific integrated circuit having an appropriate combined logic gate circuit, a programmable gate array (PGA), and a field programmable gate array (FPGA), etc.

The description or blocks in the flowcharts or of any process or method in other manners may be understood as being indicative of comprising one or more modules, segments or parts for realizing the codes of executable instructions of the steps in specific logic functions or processes, and that the scope of the preferred embodiments of the present disclosure comprise other implementations, wherein the functions may be executed in manners different from those shown or discussed, including executing the functions according to the related functions in a substantially simultaneous manner or in a reverse order, which should be understood by those skilled in the art to which the present disclosure pertains.

The logic and/or steps shown in the flowcharts or described in other manners here may be, for example, understood as a sequencing list of executable instructions for realizing logic functions, which may be implemented in any computer readable medium, for use by an instruction executing system, device or apparatus (such as a system including a computer, a system including a processor, or other systems capable of extracting instructions from an instruction executing system, device or apparatus and executing the instructions), or for use in combination with the instruction executing system, device or apparatus.

The above literal description and drawings show various features of the present disclosure. It should be understood that a person of ordinary skill in the art may prepare suitable computer codes to carry out each of the steps and processes described above and illustrated in the drawings. It should also be understood that the above-described terminals, computers, servers, and networks, etc. may be any type, and the computer codes may be prepared according to the disclosure contained herein to carry out the present disclosure by using the devices.

Particular embodiments of the present disclosure have been disclosed herein. Those skilled in the art will readily recognize that the present disclosure is applicable in other environments. In practice, there exist many embodiments and implementations. The appended claims are by no means intended to limit the scope of the present disclosure to the above particular embodiments. Furthermore, any reference to “a device to . . . ” is an explanation of device plus function for describing elements and claims, and it is not desired that any element using no reference to “a device to . . . ” is understood as an element of device plus function, even though the wording of “device” is included in that claim.

Although a particular preferred embodiment or embodiments have been shown and the present disclosure has been described, it is obvious that equivalent modifications and variants are conceivable to those skilled in the art in reading and understanding the description and drawings. Especially for various functions executed by the above elements (portions, assemblies, apparatus, and compositions, etc.), except otherwise specified, it is desirable that the terms (including the reference to “device”) describing these elements correspond to any element executing particular functions of these elements (i.e. functional equivalents), even though the element is different from that executing the function of an exemplary embodiment or embodiments illustrated in the present disclosure with respect to structure. Furthermore, although the particular feature of the present disclosure is described with respect to only one or more of the illustrated embodiments, such a feature may be combined with one or more other features of other embodiments as desired and in consideration of advantageous aspects of any given or particular application.

1. A method performed by a mobile electronic device for unlocking a screen of the mobile electronic device, the method comprising:
sensing with the mobile electronic device and a near field communication tag;
determining with the mobile electronic device whether the near field communication tag is an approved near field communication tag;
when the sensed near field communication tag is the approved near field communication tag:
receiving a biometric feature of a user; and
determining whether the received biometric feature matches an authorized biometric feature;
when the received biometric feature matches the authorized biometric feature, unlocking a screen of the mobile electronic device.

2. The method according to claim 1, wherein:
when the mobile electronic device is rooted or switched on and the approved near field communication tag is not sensed by the mobile device, requiring a passcode to unlock the screen of the mobile electronic device.

3. The method according to claim 1, wherein the biometric feature of the user comprises at least one of the following of the user: a fingerprint, a face, an iris, a palm print, or a voice.

4. The method according to claim 1, wherein the method further comprises:
when the authorized near field communication tag 1 s sensed, an unlocking program is executed and the unlocked program receives the biometric feature from the user.

5. The method according to claim 1, wherein the near field communication tag comprises a universal tag, and a configuration program is used in the mobile electronic device to identify the near field communication tag as the authorized near field communication tag.

6. The method according to claim 5, wherein the configuration program is a universal third-party program.

7. The method according to claim 1, wherein the near field communication tag comprises a specific tag of the mobile electronic device, and the near field communication tag and the mobile electronic device are bound in advance.

8. The method according to claim 7, wherein the near field communication tag contains identification information of the mobile electronic device.

9. A mobile electronic device comprising:
a screen;
a near field communication sensor configured to sense a near field communication tag;
a biometric sensor configured to generate biometric feature data from a biometric feature of a user of the mobile electronic device;
a processor configured to:
lock the screen to prevent operation of the mobile electronic device by an unauthorized user;
receive data from the sensor regarding the near field communication tag;
determining whether the near field communication tag is an approved near field communication tag;
when the sensed near field communication tag is the approved near field communication tag:
receiving the biometric feature data from the biometric sensor;
determining whether the received biometric feature matches an authorized biometric feature;
when the received biometric feature matches the authorized biometric feature, unlocking a screen of the mobile electronic device.

10. The mobile electronic device according to claim 9, wherein when the mobile electronic device is rooted or switched on and the approved near field communication tag is not sensed by the mobile device, requiring a passcode to unlock the screen of the mobile electronic device.

11. The mobile electronic device according to claim 9, wherein the biometric feature of the user comprises at least one of the following of the user: a fingerprint, a face, an iris, a palm print, or a voice identification.

12. The mobile electronic device according to claim 9, wherein the processor is further configured to:
when the authorized near field communication tag 1 s sensed, execute an unlocking program, such that the unlocked program receives the biometric feature data.

13. The mobile electronic device according to claim 9, wherein the near field communication tag comprises a universal tag, and the processor executes a configuration program to identify the near field communication tag as the authorized near field communication tag.

14. The mobile electronic device according to claim 9, wherein the near field communication tag comprises a specific tag of the mobile electronic device, and the near field communication tag and the mobile electronic device are bound in advance.

15. The mobile electronic device according to claim 14, wherein the near field communication tag contains identification information of the mobile electronic device.
